(19) United States
(12) Patent Application Publication
(10) Pub. No.: US 2025/0182069 A1
(43) Pub. Date: Jun. 5, 2025

(54) TECHNIQUES FOR HANDLING TRANSACTION-RELATED DATA

(71) Applicant: Stripe, Inc., South San Francisco, CA (US)

(72) Inventors: Anthony PIANTA, Washington, DC (US); Johan ADAMI, Brooklyn, NY (US); Nikhil CHATURVEDI, Vancouver (CA); Edward MANCEBO, Seattle, WA (US)

(21) Appl. No.: 18/526,702

(22) Filed: Dec. 1, 2023

(51) Int. Cl. G06Q 20/02; G06Q 20/40

(52) U.S. Cl. CPC G06Q 20/027; G06Q 20/4016; G06Q 20/407

(57) ABSTRACT

Embodiments provide resource-efficient and scalable techniques to process transaction-related data and make the transaction-related data available in a uniform and accessible manner. In one embodiment, a transaction event data pipeline may be utilized to collect events, process the events, such as by removing irrelevant or duplicative data. Further, enriched events may be generated based on the event processing. For example, enriched events may combine a plurality of events from one or more sources into a single event with a predetermined format. In several embodiments, generation of enriched events may facilitate scalability, such as by reducing the state size of various event processing components.

### FIELD OF DISCLOSURE

This disclosure is related generally to handling transaction-related data and more particularly to a transactional event data pipeline for processing and exposing transaction-related data.

### BACKGROUND

Merchants, such as grocers, car services, dry cleaning services, online marketplaces, etc., provide their products and services to consumers. Such merchants may employ agents to deliver their products and/or provide the actual services to the merchant's customers. For example, a person acting on the merchant's behalf will drive a consumer in their own car, deliver food ordered through a merchant website, pick up and/or drop off clothes dry cleaned by the merchant, etc.

These merchants, although providing systems for supplying products and/or services to consumers, often do not perform the financial processing associated with the merchant transactions. Instead, merchants utilize commerce systems to process financial transactions for the products and/or services provided to consumers. This may include the merchant, agent, and other users establishing accounts with the commerce system. Once the accounts are established, merchants can run financial transactions using the services of the commerce system, merchant agents can accept payments from customers on behalf of the merchant for provided products and/or services, and the commerce system can process the payments, performs payouts for services rendered, as well as other financial processing services. This processing of payments by the commerce platform may include running credit cards, crediting a merchant account for the transaction, crediting the agent responsible for the transaction, debiting a commerce system fee for processing the transaction on behalf of the merchant, interacting with authorization network systems (e.g., bank systems, credit card issuing systems, etc.), as well as performing other commerce related transactions for the merchant and/or agent such as providing payouts for products/services rendered on behalf of a merchant.

To prevent fraudulent transactions, such as when a proffered payment is made with a stolen card number, a card number from an expired card, a spoofed card, etc., the commerce system may perform fraud detection for the transactions. Such fraud detection can include attempting to determine, based on parameters associated with a transaction, whether there is a likelihood that the transaction is fraudulent. For example, whether a card number is associated with past fraudulent transactions, whether the transaction amount or purchase location is a-typical for the card number, what IP address a remote transaction has originated from, etc. Thus, the fraud detection seeks to determine when one or more factors associated with the transaction indicate fraud, such as by employing machine learning techniques to analyze transaction data. Data regarding various aspects of a transaction may be generated, collected, and/or utilized, such as during processing a transaction. This data can provide information regarding the transaction.

### BRIEF SUMMARY

Processes, apparatuses, machines, and articles of manufacture for processing and exposing transaction-related data are described. It will be appreciated that the embodiments may be combined in any number of ways without departing from the scope of this disclosure.

Example methods, such as computer-implemented methods for handling transaction-related data, are described herein. An example method may include receiving, by a server system, a first event comprising first data regarding a transaction; receiving, by the server system, a second event comprising second data regarding the transaction; determining, by the server system, the second event comprises a trigger event; initializing, by the server system, a delay timer for a threshold amount of time in response to determining the second event comprises the trigger event; receiving, by the server system, a third event comprising third data regarding the transaction prior to expiration of the delay timer; generating, by the server system, a first enriched event based on the first, second, and third events in response to expiration of the delay timer, the first enriched event including first enriched data comprising at least a portion of the first data, the second data, or the third data; and populating, by the server system, a portion of a set of data fields of an entry corresponding to the transaction in a data store, the portion of the set of data fields for the entry populated based on the first enriched event, and the data store including a plurality of entries with each entry having a data structure including the set of data fields.

Example non-transitory computer-readable media are disclosed herein. An example non-transitory computer-readable storage medium includes instructions that, when executed by a processor, cause the processor to perform operations for handling transaction-related data, the operations comprising: receiving, by a server system, a first event comprising first data regarding a transaction; receiving, by the server system, a second event comprising second data regarding the transaction; determining, by the server system, the second event comprises a trigger event; initializing, by the server system, a delay timer for a threshold amount of time in response to determining the second event comprises the trigger event; receiving, by the server system, a third event comprising third data regarding the transaction prior to expiration of the delay timer; generating, by the server system, a first enriched event based on the first, second, and third events in response to expiration of the delay timer, the first enriched event including first enriched data comprising at least a portion of the first data, the second data, or the third data; and populating, by the server system, a portion of a set of data fields of an entry corresponding to the transaction in a data store, the portion of the set of data fields for the entry populated based on the first enriched event, and the data store including a plurality of entries with each entry having a data structure including the set of data fields.

Example server computer systems are disclosed herein. An example server computer system for handling transaction-related data comprises a memory and a processor coupled to the memory configured to: receive, by a server system, a first event comprising first data regarding a transaction; receive, by the server system, a second event comprising second data regarding the transaction; determine, by the server system, the second event comprises a trigger event; initialize, by the server system, a delay timer for a threshold amount of time in response to determining the second event comprises the trigger event; receive, by the server system, a third event comprising third data regarding the transaction prior to expiration of the delay timer; generate, by the server system, a first enriched event based on the first, second, and third events in response to expiration of the delay timer, the first enriched event including first enriched data comprising at least a portion of the first data, the second data, or the third data; and populate, by the server system, a portion of a set of data fields of an entry corresponding to the transaction in a data store, the portion of the set of data fields for the entry populated based on the first enriched event, and the data store including a plurality of entries with each entry having a data structure including the set of data fields.

Handling transaction-related data in this manner allows for transaction-related data to be made available in a quick and efficient manner that is scalable without introducing computationally demanding steps and redundant or unnecessary steps. In turn, this allows for efficient and reliable availability of transaction-related data without introducing unwanted delays, complexity, and latency.

Other processes, machines, and articles of manufacture are also described herein, which may be combined in any number of ways, such as with the embodiments of the brief summary, without departing from the scope of this disclosure.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

To easily identify the discussion of any particular element or act, the most significant digit or digits in a reference number refer to the figure number in which that element is first introduced.

FIG. 1 illustrates a block diagram of an exemplary system architecture for processing and exposing transaction-related data according to some embodiments.

FIG. 2 illustrates an operating environment for a transaction event data pipeline according to some embodiments.

FIG. 3 illustrates various aspects of event producers in conjunction with a transaction event data pipeline according to some embodiments.

FIG. 4 illustrates a process flow for a transaction event data pipeline according to some embodiments.

FIG. 5 illustrates a logic flow for emitting enriched events according to some embodiments.

FIG. 6 illustrates a logic flow for handling events stored at an enrichment engine according to some embodiments.

FIG. 7 illustrates a logic flow of an exemplary method for handling transaction-related events according to some embodiments.

FIG. 8 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “initializing”, “generating”, “populating”, “updating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes techniques for handling transaction-related data. More specifically, embodiments are directed to a server system for implementing a transaction event data pipeline that processes and/or exposes transaction-related data. For example, embodiments may include various components that receive events with transaction-related data (also referred to as event data), generate enriched events, distribute the events or transaction-related data, condition transaction-related data, store transaction-related data, make transaction-related data available, and/or distribute transaction-related data. In various embodiments, the transaction event data pipeline may receive various transaction-related events as input and output data regarding the transactions in a manner that is uniform and accessible. These and other embodiments are described and claimed.

Existing techniques for handling transaction-related data fail to process the data in an efficient manner that makes the data readily accessible and available for analyzing, characterizing, and testing purposes. For example, data regarding various aspects of a transaction may be generated at different times, be generated by different components, be generated in different formats, include different or duplicative information, and/or be stored in different locations, resulting in a difficult and resource intensive process to locate and utilize the data for analyzing, characterizing, and testing purposes. These limitations can drastically reduce the usability and applicability of transaction-related data processing systems, contributing to unacceptable latency, unavailable or inaccessible data, excessive reliance on manual processes, unnecessarily high resource requirements, and inefficient systems, devices, and techniques with limited capabilities.

Accordingly, many embodiments disclosed herein provide resource-efficient and scalable techniques to process transaction-related data and make the transaction-related data available in a uniform and accessible manner. In one embodiment, a transaction event data pipeline may be utilized to collect events, process the events, such as by removing irrelevant or duplicative data. Further, enriched events may be generated based on the event processing. For example, enriched events may combine a plurality of events from one or more sources into a single event with a predetermined format. In several embodiments, generation of enriched events may facilitate scalability, such as by reducing the state size of various event processing components. For example, as will be described in more detail below, various triggers and processing logic techniques may be utilized to minimize retention of events and/or minimize generation of enriched events.

The enriched events may be utilized to populate, maintain, or update a data structure that describes transactions with a common set of attributes. In many embodiments, the data structure can be updated in near-real time to make transaction-related data readily available. The data structure can be utilized for analyzing, characterizing, and testing purposes. For example, merchants may utilize the data structure for analyzing prior transactions for fraud, characterize prior transactions as fraudulent, and back testing rules for identifying fraudulent transactions. In many embodiments, the data structure may be stored in a manner that allows for efficient and low-latency querying.

In these and other ways, components/techniques described herein provide many technical advantages. For instance, the computer-based techniques of the current disclosure improve the functioning of a server systems for transaction-related data processing as compared to conventional approaches because the techniques enable transaction-related data to be made readily available in a usable format that reduces latency, improves resource efficiency, scales, and, and provides expanded capabilities versus conventional approaches. Accordingly, embodiments disclosed herein can be practically utilized to improve the functioning of a computer and/or to improve a variety of technical fields including transaction-related data processing, data pipelines, server systems, event streaming, commerce platforms, data latency, data availability, and/or user experience.

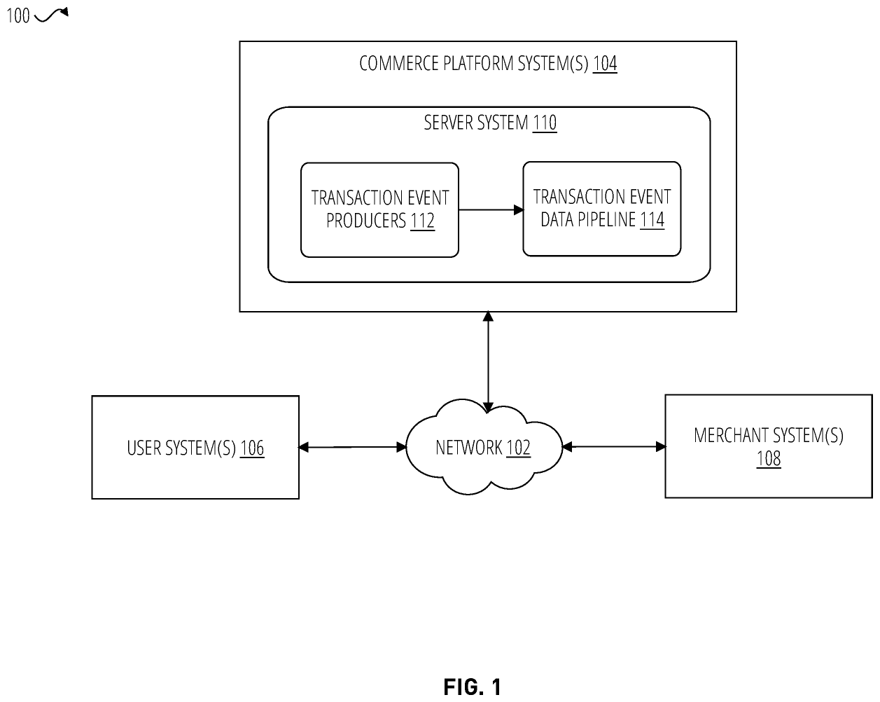

FIG. 1 is a block diagram of an exemplary system architecture 100 for processing and exposing transaction-related data according to some embodiments. In one embodiment, the system 100 includes one or more commerce platform systems 104, one or more merchant systems 108, and one or more user systems 106. In one embodiment, one or more systems (e.g., systems 106 and 108) may be mobile computing devices, such as a smartphone, tablet computer, smartwatch, etc., as well computer systems, such as a desktop computer system, laptop computer system, server computer systems, etc. The commerce platform systems 104 and merchant systems 108 may also be one or more computing devices, such as one or more server computer systems, desktop computer systems, etc. Furthermore, there may be any number of user systems 106 and/or merchant systems 108 utilizing the services of the commerce platform systems 104. However, to avoid obscuring the present description, only one commerce platform system 104, user system 106, and merchant system 108 are generally illustrated and described.

Furthermore, it should be appreciated that the embodiments discussed herein may be utilized by a plurality of different types of systems, such as other commerce platform system(s) including payment processing systems, card authorization systems, banks, and other systems seeking to identify and detect fraud during transactions. Furthermore, any system seeking to handle transaction-related data may use and/or extend the techniques discussed herein to improve efficiency, scalability, and/or availability of transaction-related data. However, to avoid obscuring the embodiments discussed herein, transaction-related data handling (e.g., via a transaction event data pipeline 114), is discussed to illustrate and describe the embodiments of the present invention, and is not intended to limit the application of the techniques described herein to other systems in which transaction-related data handling could be used.

The commerce platform system 104, merchant system 108, and user system 106 may be coupled to a network 102 and communicate with one another using any of the standard protocols for the exchange of information, including secure communication protocols. In one embodiment, one or more of the commerce platform system 104, merchant system 108, and user system 106 may run on one Local Area Network (LAN) and may be incorporated into the same physical or logical system, or different physical or logical systems. Alternatively, the commerce platform system 104, merchant system 108, and user system 106 may reside on different LANs, wide area networks, cellular telephone networks, etc. that may be coupled together via the Internet but separated by firewalls, routers, and/or other network devices. In one embodiment, commerce platform system 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, commerce platform system 104 provides financial processing services to one or more merchants, such as to merchant system 108 and/or user system 106 that act as an agent of merchant system 108. For example, commerce platform system 104 may manage merchant accounts held at the commerce platform, run financial transactions from user system 106 performed on behalf of a merchant, clear transactions, performing payouts to merchant and/or merchant agents, manage merchant and/or agent accounts held at the commerce platform system 104, as well as other services typically associated with commerce platforms systems such as, for example, STRIPE™.

To handle transaction-related data, in embodiments, commerce platform system 104 utilize a server system 110 including one or more transaction event producers 112 and a transaction event data pipeline 114. As will be discussed in greater detail below, the transaction event data pipeline 114 may receive events including data related various aspects of a transaction from the transaction event producers 112 and efficiently process the events to make transaction-related data available in a uniform, scalable, and readily accessible manner. In some examples, the transaction event producers 112 and transaction event data pipeline 114 operate substantially independently from each other. Thus, one or more embodiments described herein generally decouple generation of events (as performed by transaction event producers 112) and handling of the transaction-related data (as performed by transaction event data pipeline 114), such as in response to processing a transaction (e.g., using a charge path (CP)), to provide improved handling of transaction-related data.

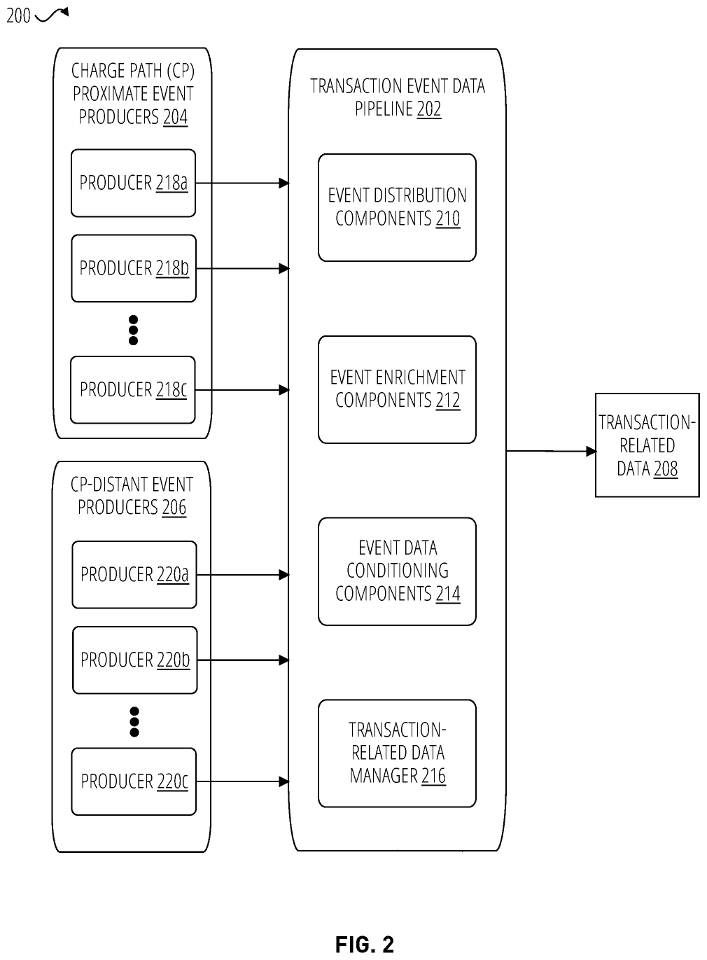

FIG. 2 illustrates an operating environment 200 for a transaction event data pipeline according to some embodiments. The operating environment 200 includes a plurality of CP-proximate event producers 204, a plurality of CP-distant event producers 206, a transaction event data pipeline 202, and transaction-related data 208. The CP-proximate event producers 204 may include one or more producers 218a, 218b, 218c (collectively referred to as producers 218) and the CP-distant event producers 206 may include one or more producers 220a, 220b, 220c (collectively referred to as producers 220). The transaction event data pipeline 202 includes one or more event distribution components 210, one or more event enrichment components 212, one or more event data conditioning components 214, and a transaction-related data manager 216. In various embodiments, the transaction event data pipeline 202 may receive, distribute, enrich, condition, and/or manage transaction events from the CP-proximate event producers 204 and CP-distant event producers 206 to produce transaction-related data 208 and make transaction-related data 208 readily available for analyzing, characterizing, and/or testing purposes. It will be appreciated that one or more components of FIG. 2 may be the same or similar to one or more other components disclosed herein. For example, transaction event data pipeline 202 may be the same or similar to transaction event data pipeline 114. In another example, CP-proximate event producers 204 and/or CP-distant event producers 206 may be the same or similar to transaction event producers 112. Further, aspects discussed with respect to various components in FIG. 2 may be implemented by one or more other components from one or more other embodiments without departing from the scope of this disclosure. Embodiments are not limited in this context.

The event producers may generate events in response to various operations corresponding to a transaction and the events may include data related to the transaction. In various embodiments, events may be generated according to an event streaming service architecture. As discussed in more detail below, in several embodiments, one or more components of transaction event data pipeline 202, CP-proximate event producers 204, and CP-distant event producers 206 may implement one or more aspects of an event streaming platform.

In many embodiments, CP-proximate event producers 204 may correspond to event producers that generate events in response to operations that are relatively proximate in time to the charge path while CP-distant event producers 206 may generate events in response to operations that are relatively distant in time to the charge path. Relatively proximate in time to the charge path may include events that are generated based on, or in response to, operations performed in the charge path. For example, CP-proximate events may include events generated based on gateway outcomes, attribute retrievals, and/or fraud analysis performed as part of the charge path. In many such examples, generation of CP-proximate events may be triggered by execution of the charge path, but occur asynchronously with the charge path.

On the other hand, relatively distant in time to the charge path may include events that are generated based on, or in response to, operations that are performed, or completed, subsequent to the charge path. For example, CP-distant events may include events generated after a transaction has been processed, such as refunds or disputes. In some embodiments, CP-distant events may include transaction-related data from transaction analysis or fraud analysis that is performed outside of the charge path. For example, a first fraud analysis may be performed as part of the charge path and a second fraud analysis may be performed outside of the charge path. In such examples, the first fraud analysis may be less in-depth than the second fraud analysis in order to keep latency of the charge path low.

In various embodiments, the events generated by CP-proximate event producers 204 and CP-distant event producers 206 may be consumed by one or more components of the transaction event data pipeline 202 to produce transaction-related data 208. In various embodiments, one or more event distribution components 210 may receive and distribute the events to one or more event enrichment components 212. For example, event distribution components 210 may include topics and/or an aggregator of topics. In some embodiments, the topics may be subscribed to by other components, such as event enrichment components 212. Accordingly, when the event distribution components 210 receive events, they may distribute them to one or more event enrichment components 212. Some event distribution components 210 may classify or organize events. For example, event distribution components 210 may include an event bus that partitions enriched events based on an identifier (e.g., charge or transaction identifier). In some embodiments, event distribution components 210 may support grouping events based on end consumers. For example, different event distribution components 210 may correspond to different end consumers of the transaction-related data 208 (e.g., different merchants or banks).

The event enrichment components 212 may generate one or more enriched events based on the events. For example, event enrichment components 212 may implement one or more sets of rules in generating the enriched events. The set of rules may determine which data to include and which data to exclude from the enriched event. For instance, duplicative data may be excluded from the enriched event. In an additional, or alternative instance, data may be excluded based on privacy policies. In one embodiment, data based on transactions across the entire server system may be excluded or redacted from enriched events to prevent said data from being exposed to merchants in violation of a privacy policy. Accordingly, many embodiment may improve system integrity and confidentiality. In some embodiments, events may be filtered out prior to being stored by the event enrichment components 212. For example, duplicative events or events deemed not relevant may be filtered out.

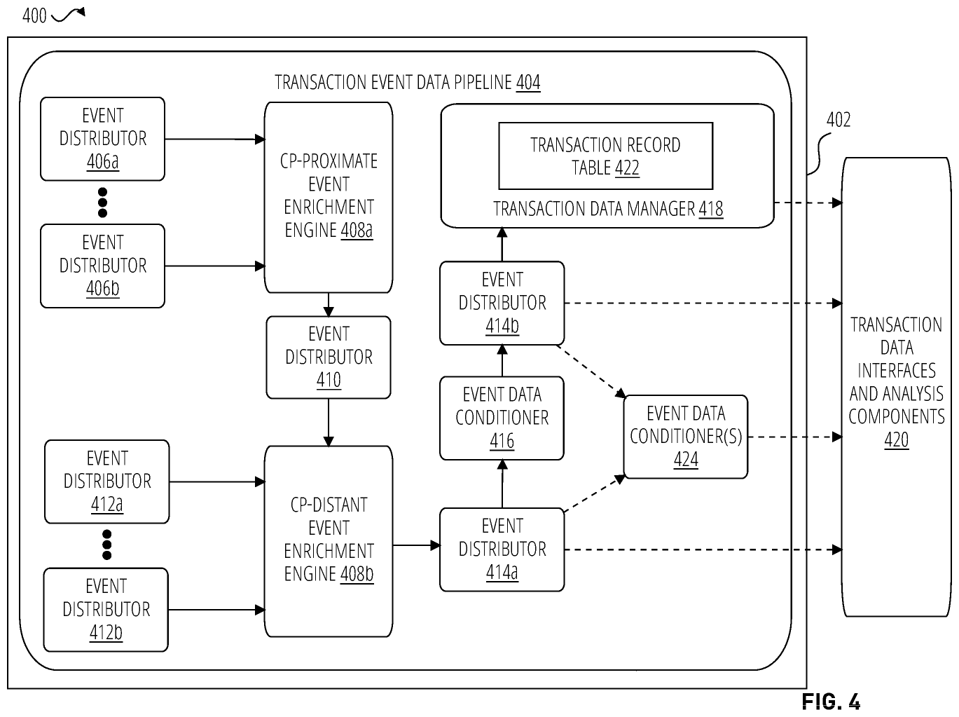

As discussed in more detail below, such as with respect to FIG. 4, in many embodiments, event enrichment components 212 may implement various data retention policies and/or delay timers for enriched event generation to improve efficiency and reduce computer resource demands. For example, introducing a delay that causes an enrichment engine to wait until all or a majority of events have been emitted before generating and emitting an enriched event can reduce the number of enriched events that are generated and the processing of those events (e.g., to determine whether the transaction record table needs to be updated to include transaction-related data in the enriched event). Further, in many embodiments, the retention policies may be used to reduce computer resource demands and/or system responsiveness. For example, reducing the number of events stored by an enrichment engine can enable additional instances of enrichment engines to be instantiated quicker. Such improvements and others described hereby can be critical to the scalability and dynamic adaptability of transaction-related data handling systems. In various embodiments, the retention policy of an enrichment engine may be based on the types of events received and processed. For example, CP-proximate event enrichment engines may utilize retention policies of 12 to 48 hours and CP-distant enrichment engines may utilize retention policies of 90 to 365 days. In such examples, the retention policies may be configured to ensure events related to a particular transaction are received prior to the first event being discarded. Accordingly, CP-proximate events (e.g., gateway outcome or transaction attribute events) for a transaction are expected to be received for a transaction within 12 to 48 hours and CP-distant events (e.g., refund or dispute events) are expected to be received for a transaction within 90 to 365 days. Accordingly, by utilizing different enrichment engines for CP-proximate and CP-distant events, the efficiency of the system can be improved, such as due to not needing to retain CP-proximate events until all CP-distant events have been, or are expected to be, received.

Additionally, enriched events may utilize specified formats and structures to support downstream processing, such as by event data conditioning components 214. Further, event data conditioning components 214 may condition data included in enriched events for storage as transaction-related data 208 and/or distribution to other components. In some embodiments, event data conditioning components 214 may encode data according to one or more schemes. For example, encoding may be utilized to reduce the size of transaction-related data 208. In various embodiments, event data conditioning components 214 may organize and/or classify various enriched events. In various embodiments, event data conditioning components 214 may include an event bus that partitions enriched events based on an identifier (e.g., charge or transaction identifier). In several embodiments, event data conditioning components 214 may produce different events for different users and end consumers (e.g., different merchants or banks).

In many embodiments, the different events may be received by one or more event distribution components 210 (e.g., one or more event busses) for distribution to one or more other components, such as for storage in different transaction record tables corresponding to the different users and end consumers. The transaction-related data manager 216 may be responsible for populating, maintaining, and updating various data stores and data consumers with the transaction-related data 208. For example, as discussed in more detail below, the data stores may include one or more transaction event tables that store the transaction-related data 208 in a uniform and indexed manner. In many embodiments, transaction-related data 208 may be made available to consumers in a short amount of time to enable the consumers to adapt based on the data. For example, transaction-related data 208 may be made available to consumers within a few minutes and be updated as additional data is received in additional events (e.g., a refund or dispute event).

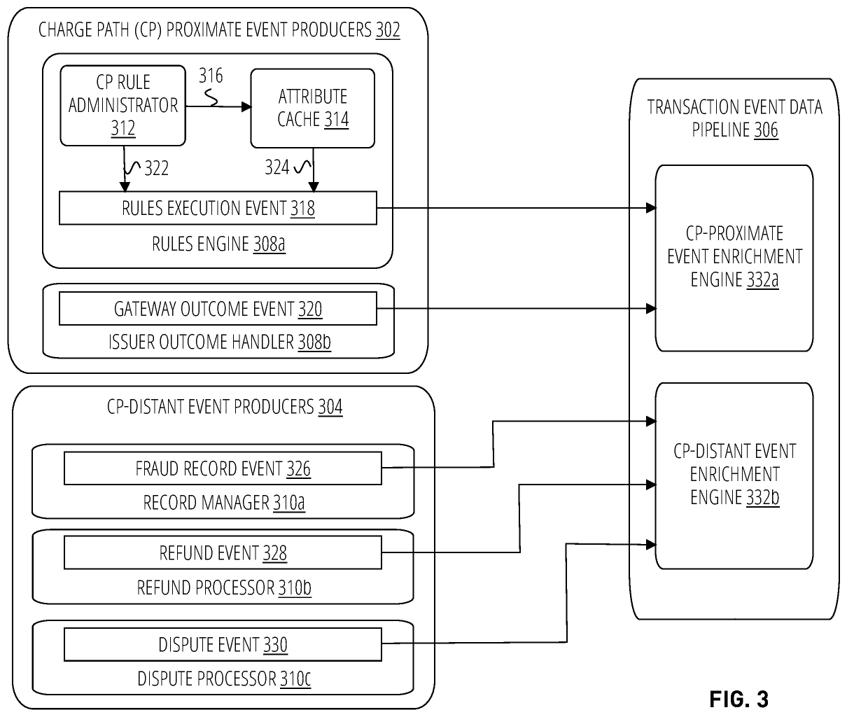

FIG. 3 illustrates various aspects of event produces in conjunction with a transaction event data pipeline according to some embodiments. The illustrated embodiment includes CP-proximate event producers 302, CP-distant event producers 304, and transaction event data pipeline 306. In various embodiments, the CP-proximate event producers 302 may generate events associated with various operations that occur proximate (e.g., in time) to the charge path for processing a transaction and the CP-distant event producers 304 may generate events associated with various operations that occur distant (e.g., in time) to the charge path for processing a transaction. For example, events generated by CP-proximate event producers 302 may include transaction-related data associated with rule execution (e.g., rule execution outcomes and/or attributes regarding a transaction that are utilized during rule execution) and/or gateway outcomes that occur within or adjacent to the charge path. In another example, events generated by CP-distant event producers 304 may include transaction-related data associated with fraud records, refunds, and/or disputes that occur subsequent to processing the transaction via the charge path.

In the illustrated embodiment, CP-proximate event producers 302 include one or more portions or components associated with a rules engine 308a and an issuer outcome handler 308b. Further, CP-distant event producers 304 include one or more portions or components associated with a record manager 310a, a refund processor 310b, and a dispute processor 310c. The transaction event data pipeline 306 may include a CP-proximate event enrichment engine 332a and a CP-distant event enrichment engine 332b. The CP-proximate event enrichment engine 332a may generate enriched events based on the events received from the CP-proximate event producers 302 and the CP-distant event enrichment engine 332b may generate enriched events based on events received from the CP-distant event producers 304.

It will be appreciated that one or more components of FIG. 3 may be the same or similar to one or more other components disclosed herein. For example, transaction event data pipeline 306 may be the same or similar to transaction event data pipeline 114 or transaction event data pipeline 202. In another example, rules engine 308a and issuer outcome handler 308b (or components thereof or associated therewith) may be the same or similar to producer 218a and producer 218b, respectively. In yet another example, record manager 310a, refund processor 310b, and dispute processor 310c (or components thereof or associated therewith) may be the same or similar to producer 220a, producer 220b, and 220c, respectively. Further, aspects discussed with respect to various components in FIG. 3 may be implemented by one or more other components from one or more other embodiments without departing from the scope of this disclosure. Embodiments are not limited in this context.

In the illustrated embodiment, CP-proximate event producers 302 include a rules engine 308a and an issuer outcome handler 308b. One or more components of the rules engine 308a and the issuer outcome handler 308b may implement a portion of the charge path. The rules engine 308a includes a CP rule administrator 312, an attribute cache 314, and emits (or causes to be emitted) a rules execution event 318. In many embodiments, the CP rule administrator 312 may retrieve various attributes associated with a transaction. These attributes may be utilized to implement one or more rules, such as regarding whether or not to continue processing a transaction. The CP rule administrator 312 may provide rule administration data 322 for inclusion in a rules execution event 318. For example, rule administration data 322 may include rule outcomes and/or attributes retrieved to implement the rules. In various embodiments, the CP rule administrator 312 may, asynchronously with the charge path, cause additional attributes to be retrieved (i.e., asynchronous attributes 316). The additional attributes may be stored in attribute cache 314 and included in the rules execution event 318 as remaining attributes 324.

The issuer outcome handler 308b may emit (or cause to be emitted) a gateway outcome event 320. The gateway outcome event 320 may include data regarding whether or not a transaction was approved by a bank or other interested entity. For example, a gateway outcome may be obtained as part of the charge path, such as to determine whether a bank approves a transaction. In response to the gateway outcome, gateway outcome event 320 may be emitted. In various embodiments, the rules execution event 318 and gateway outcome event 320 may be communicated to CP-proximate event enrichment engine 332a of transaction event data pipeline 306. In various such embodiment, the rules execution event 318 and gateway outcome event 320 may be communicated to CP-proximate event enrichment engine 332a via one or more other components, such as an event distributor and/or a filter component of the transaction event data pipeline 306.

In many embodiments, one or more CP-proximate events may include a trigger event. For example, gateway outcome event 320 generated by issuer outcome handler 308b may comprise a trigger event. In various embodiments, trigger events may include events that are generated near or after the end of processing a transaction, such as via a charge path. In various such embodiments, the trigger events may be predefined. On the other hand, non-trigger events may include events that are not generated near or after the end of processing a transaction, such as via a charge path. More generally, trigger events may include events that indicate CP proximate events regarding a transaction have finished or are close to finished being emitted for a transaction. As discussed in more detail below, trigger events may be utilized to start a delay timer. When the delay timer expires, the CP-proximate event enrichment engine 332a may emit an enriched event based on the events received for a transaction. Introducing a delay that causes an event enrichment engine to wait until all or a majority of CP-proximate events have been emitted before generating and emitting an enriched event can reduce the number of enriched events that are generated and the processing of those events (e.g., to determine whether the transaction record table needs to be updated to include transaction-related data in the enriched event). Reducing the number of enriched events that are generated enables the system to operate more efficiently.

The CP-distant event producers 304 includes a record manager 310a, a refund processor 310b, and a dispute processor 310c. Although not illustrated, in some embodiments, one or more of the record manager 310a, refund processor 310b, and dispute processor 310c may include a rule administrator that includes logic for determining when to generate an event. However, the record manager 310a, refund processor 310b, and dispute processor 310c do not include CP rule administrators because they do not emit events based on operations performed in the charge path. The record manager 310a may emit a fraud record event 326 associated with a transaction. For example, the fraud record event 326 may include fraud records corresponding to one or more entities associated with a transaction, such as an email address, a bank identification number (BIN), a card number, a name, an IP address, an address, and the like). In various embodiments, the fraud record event 326 may include additional data and/or a more in-depth fraud analysis regarding a transaction. For example, fraud record event 326 may include data regarding a more in-depth fraud analysis than the fraud analysis that is performed as part of the charge path. The refund processor 310b may emit a refund event 328 in response to a refund being initiated for a transaction. Similarly, the dispute processor 310c may emit a dispute event 330 in response to a dispute being initiated for a transaction. In various embodiments, the fraud record event 326, refund event 328, and dispute event 330 may be communicated to CP-distant event enrichment engine 332b of transaction event data pipeline 306. In various such embodiment, the fraud record event 326, refund event 328, and dispute event 330 may be communicated to CP-distant event enrichment engine 332b via one or more other components, such as an event distributor and/or a filter component of the transaction event data pipeline 306.

In various embodiments, the CP-proximate event producers 302 and CP-distant event producers 304 may generate multiple events for each transaction. For example, multiple rules execution events 318 or multiple gateway outcome event 320 may be generated and emitted. In another example, an event may be emitted based on initiation of a dispute and a second event may be emitted based on resolution of the event. In such examples, filtering components, event distributors, data conditioners, data managers, and/or enrichment engines may be utilized to consolidate the plurality of events and update the available transaction-related data 208 in an efficient and scalable manner.

FIG. 4 illustrates a process flow 400 for a transaction event data pipeline 404 according to some embodiments. In the illustrated embodiment, the transaction event data pipeline 404 processes events quickly and efficient make relevant portion of transaction-related data associated with the events available to transaction data interfaces and analysis components 420. The transaction event data pipeline 404 includes one or more event distributors 406a, 406b (collectively referred to as event distributors 406), a CP-proximate event enrichment engine 408a, an event distributor 410, a CP-distant event enrichment engine 408b, one or more event distributors 412a, 412b (collectively referred to as event distributors 412), event distributors 414a, 414b (collectively referred to as event distributors 414), event data conditioner 416, transaction data manager 418 with transaction record table 422, and one or more event data conditioner(s) 424. It will be appreciated that one or more components of FIG. 4 may be the same or similar to one or more other components disclosed herein. For example, CP-proximate event enrichment engine 408a and CP-distant event enrichment engine 408b may be the same or similar to event enrichment components 212. In another example, one or more of event distributors 406, 410, 412, 414 may be the same or similar to event distribution components 210. In yet another example, one or more of event data conditioners 416, 424 may be the same or similar to event data conditioning components 214. In still another example, transaction data manager 418 and transaction record table 422 may be the same or similar to transaction-related data manager 216 and transaction-related data 208, respectively. Further, aspects discussed with respect to various components in FIG. 4 may be implemented by one or more other components from one or more other embodiments without departing from the scope of this disclosure. Embodiments are not limited in this context.

In various embodiments, the CP-proximate event enrichment engine 408a may receive one or more events from event distributors 406. The CP-proximate event enrichment engine 408a may emit a first enriched event corresponding to a transaction based on the one or more events received from event distributors 406. In some embodiments, CP-proximate event enrichment engine 408a may emit the enriched event after expiration of a delay timer that is initialized based on a trigger event. The first enriched event may be communicated to event distributor 410, which may include a topic in an event streaming platform. The first enriched event may then be passed to CP-distant event enrichment engine 408b. CP-distant event enrichment engine 408b may generate a second enriched event based on the first enriched event and one or more events received from event distributors 412. In some embodiments, CP-distant event enrichment engine 408b may not receive any events corresponding to the transaction prior to receiving the first enriched event. In some such embodiments, the first enriched event may pass through, or bypass, the CP-distant event enrichment engine 408b. In various embodiments, event enrichment engines may emit more than one event for a transactions. For example, after the CP-distant event enrichment engine 408b emits an enriched event based on an enriched event emitted by CP-proximate event enrichment engine 408a, the CP-distant event enrichment engine 408b may emit a second enriched event in response to the transaction being disputed. The second enriched event may then be utilized by the transaction event data pipeline 404 to update the transaction record table 422 to indicate that the transaction is being disputed.

The event data conditioners 416, 424 may be utilized to format, organize, and/or structure transaction-related data within the enriched events. For example, event distributor 414a may include an event bus that partitions enriched events based on an identifier (e.g., charge or transaction identifier). In some embodiments, event data conditioners may emit additional events and/or transaction-related data. For example, different event data conditioners can be implemented for different end users of the transaction-related data based on the requirements or preferences of the different end users. It will be appreciated that a variety of arrangements and interactions between various components of transaction event data pipeline 404 may be utilized without departing from the scope of this disclosure. When the event distributor 414a receives an enriched event, it may distribute it to one or more other components, such as event data conditioner 416, event data conditioner(s) 424, and/or transaction data interfaces and analysis components 420. Similarly, when the event distributor 414b receives an event, it may distribute it to one or more other components, such as transaction data manager 418, event data conditioner(s) 424, and/or transaction data interfaces and analysis components 420.

In various embodiments, one or more event distributors may be utilized to distribute transaction-related data to different destinations based on the needs or requirements of the destination (e.g., regarding formatting, groupings, content, etc.). Accordingly, various data conditioners may be utilized to process various aspects transaction-related data with different event distributors being utilized to distribute the transaction-related data to various destinations at different stages of processing to facilitate providing the transaction-related data in a form that is expected, or readily usable, by the destinations. In many embodiments, this can improve system efficiency by reducing the need for various destinations to reprocess and/or reformat transaction-related data. For example, some transaction data interfaces and analysis components 420 may utilize transaction-related data in a form prior to being processed by event data conditioner 416. Accordingly, event distributor 414a may be utilized to distribute the transaction-related data to one or more destinations prior to the transaction-related data being processed by event data conditioner 416. Similarly, some transaction data interfaces and analysis components 420 may utilize transaction-related data in a form after being processed by event data conditioner 416. Accordingly, event distributor 414a may be utilized to distribute the transaction-related data to one or more destination after the transaction-related data is processed by event data conditioner 416.

The transaction data manager 418 may populate, maintain, and update transaction record table 422 based on the transaction-related data received from components of the transaction event data pipeline 404. In several embodiments, the transaction record table 422 may be made available for various end users, such as for characterizing, analyzing, and testing purposes. For example, transaction data interfaces and analysis components 420 may include back testing components and transaction record table 422 may enable the back testing components to back test potential new rules for identifying fraudulent transactions.

As previously mentioned, in many embodiments, the transaction record table 422 may utilize a data structure that includes a set of data fields corresponding to a common set of attributes utilized to describe each transaction in the table. For example, each transaction may be described by a row in the transaction record table 422 and the set of attributes may correspond to different columns in the transaction record table 422. In various embodiments, different transaction record tables 422 may be maintained for different groupings of transactions (e.g., groupings by merchant, BIN, etc.). In various such embodiments, different transaction record table 422 for different groupings of transactions may utilize different sets of attributes. In various embodiments, multiple copies of a transaction record table 422 may be created, such as for improving query latency, availability, and/or failover.

In many embodiments, the attributes may include a plurality of fields for structured data (e.g., data generated by the transaction event data pipeline 404). However, in several embodiments, the attributes may include at least one field for unstructured data. Additionally, in some embodiments, end users may be able to provide data for inclusion in the transaction record table 422 that would not otherwise be available to the transaction event data pipeline 404. For example, the unstructured data fields may enable end users to create and utilize data fields in the transaction record table 422. In some embodiments, end user provided data and/or unstructured data fields may include data supplied by a merchant, such as tracking user interactions with the merchant website. In one embodiment, end users can apply labels to transactions in the transaction record table 422.

More generally, the set of attributes included in the transaction record table 422 may include information related to a transaction, such as outcomes, processes, rules, and identifying information associated with a transaction. For example, the transaction record table 422 may include one or more of the following attributes: a charge identifier, a transaction identifier, a parent transaction identifier, a transaction type, timestamps for various operations, a payment method type, a merchant identifier, a platform identifier, a destination identifier, a live mode indicator, an event creation timestamp, an event version, a charge creation timestamp, a computed/predicted outcome, a refund identifier, a refund visibility, a refund reason, a dispute identifier, a dispute visibility, a dispute reason, an early fraud warning indicator, a fraud analysis outcome, a fraud analysis performance indicator, a gateway outcome, a gateway outcome reason, a blocking reason, authentication indicator, transaction details, user details, metadata details, rules applied, analyses performed, and the like. In various embodiments, timestamps may be utilized to determine when various fields should be updated. For example, timestamps associated with a new event may be compared to timestamps in the transaction record table 422 to determine if data is new or duplicative.

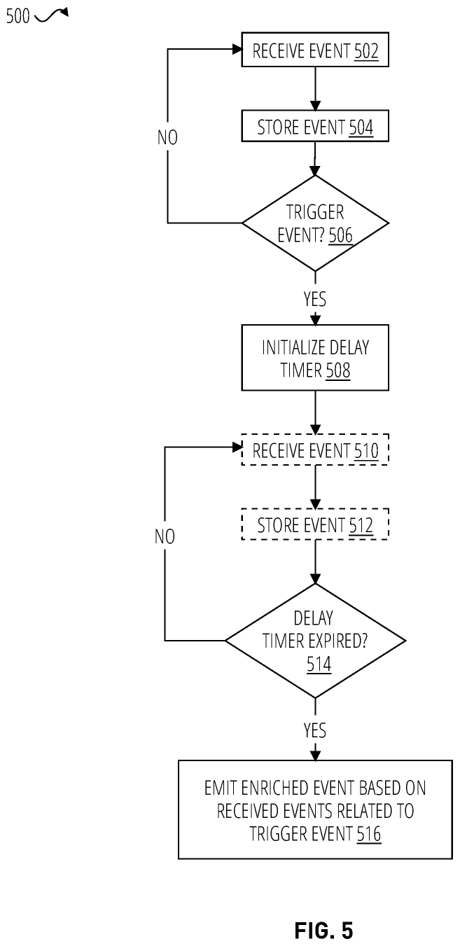

FIG. 5 illustrates a logic flow 500 for emitting enriched events according to some embodiments. The logic flow 500 is performed by processing logic that may comprise hardware (circuitry, dedicated logic, etc.), software (such as is run on a general purpose computer system or a dedicated machine), firmware, or a combination thereof. In various embodiments, the logic flow 500 is performed by one or more of a commerce platform system (e.g., commerce platform system 104), a server system (e.g., server system 110 or server system 402), and transaction event data pipeline components (e.g., CP-proximate event enrichment engine 408a of transaction event data pipeline 404). Embodiments are not limited in this context.

Referring to FIG. 5, the logic flow 500 begins at block 502. At block 502, an event may be received. For example, CP-proximate event enrichment engine 408a may receive an event including transaction-related data from event distributor 406a. Proceeding to block 504, the event may be stored. For example, CP-proximate event enrichment engine 408a may store the event in a memory. Continuing to decision block 506, it may be determined whether the event is a trigger event. For example, CP-proximate event enrichment engine 408a may analyze the event to determine if it is a trigger event. In some embodiments, a trigger event comprises a gateway outcome event. For example, gateway outcome event 320 generated by issuer outcome handler 308b may comprise a trigger event. In various embodiments, trigger events may include events that are generated near or after the end of processing a transaction, such as via a charge path. In various such embodiments, the trigger events may be predefined. On the other hand, non-trigger events may include events that are not generated near or after the end of processing a transaction, such as via a charge path. More generally, trigger events may include events that indicate CP proximate events regarding a transaction have finished or are close to finished being emitted for a transaction.

Referring back to decision block 506, if the event is determined to not be a trigger event, the logic flow 500 may return to block 502 to await reception of another event. However, if the event is determined to be a trigger event, the logic flow 500 may proceed to block 508. At block 508, a delay timer may be initialized. For example, CP-proximate event enrichment engine 408a may initialize a delay timer in response to receiving a trigger event. In some embodiments, the delay timer may have a duration between 0 and 10 seconds, such as 1 second. Proceeding to blocks 510, 512, after initializing the delay event, one or more additional events may optionally be received and stored. For example, CP-proximate event enrichment engine 408a may receive and store one or more additional events from one or more of event distributors 402 after initializing the delay timer.

Proceeding to decision block 514, it may be determined whether the delay timer has expired. If the delay timer has not expired, the logic flow 500 may continue to wait to receive and store additional events at optional blocks 510, 512. However, if the delay timer has expired, the logic flow 500 may proceed to block 516. At block 516 an enriched event may be emitted based on the received events related to the trigger event. For example, CP-proximate event enrichment engine 408a may generate an enriched event based on the trigger event and one or more other events associated with the trigger event (e.g., events corresponding to the transaction associated with the trigger event). In many embodiments, the enriched event may include transaction-related data compiled from data included in the trigger event and one or more other events associated with the trigger event. In many such embodiments, the enriched event may include transaction-related data that is relevant to populating, updating, and/or maintaining the transaction record table 422. In several embodiments, generating enriched events in this manner can improve efficiency and reduce computer resource demands. For example, introducing a delay that causes the CP-proximate event enrichment engine 408a to wait until all or a majority of CP-proximate events have been emitted before generating and emitting an enriched event can reduce the number of enriched events that are generated and the processing of those events (e.g., to determine whether the transaction record table needs to be updated to include transaction-related data in the enriched event). As discussed in more detail below, in some embodiments, trigger events and delay timers may be utilized in conjunction with data retention policies to further reduce computer resource demands.

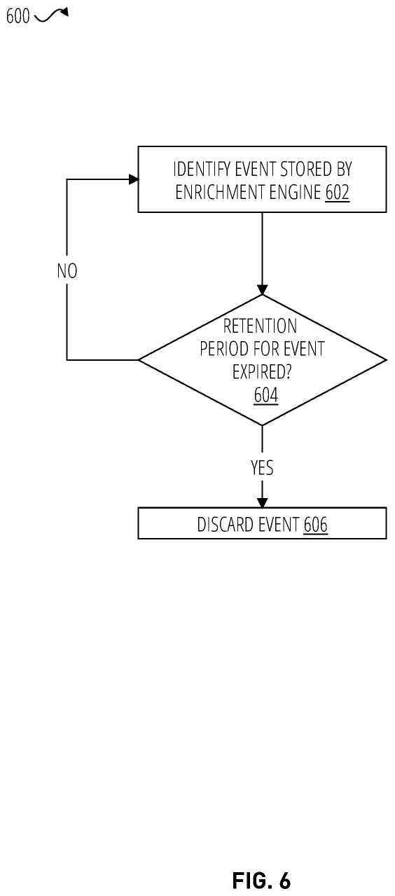

FIG. 6 illustrates a logic flow 600 for handling events stored at an enrichment engine according to some embodiments. The logic flow 600 is performed by processing logic that may comprise hardware (circuitry, dedicated logic, etc.), software (such as is run on a general purpose computer system or a dedicated machine), firmware, or a combination thereof. In various embodiments, the logic flow 600 is performed by one or more of a commerce platform system (e.g., commerce platform system 104), a server system (e.g., server system 110 or server system 402), and transaction event data pipeline components (e.g., CP-proximate event enrichment engine 408a or CP-distant event enrichment engine 408b of transaction event data pipeline 404). Embodiments are not limited in this context.

Referring to FIG. 6, the logic flow 600 begins at block 602. At block 602, an event stored by an enrichment engine may be identified. For example, CP-proximate event enrichment engine 408a may identify an event previously received from event distributor 406b. Proceeding to decision block 604, logic flow 600 may determine whether the retention period for the identified event has expired. If the retention period has not expired, the logic flow 600 may return to block 602 and identify another event stored by the enrichment engine. If the retention period has expired, logic flow 600 may proceed to block 606, where the event is discarded. It will be appreciated that logic flow 600 is provided as an exemplary technique to facilitate description of implementing retention policies in transaction-related data handling systems. However, removal of events based on a retention policy may be implemented in a variety of manners without departing from the scope of this disclosure. For example, expiration of a timer may trigger removal of an event, instead of actively checking whether the retention period for various events has expired.

In many embodiments, the retention policies may be used to reduce computer resource demands and/or system responsiveness. For example, reducing the number of events stored by an enrichment engine can enable additional instances of enrichment engines to be instantiated quicker. Such improvements and others described hereby can be critical to the scalability and dynamic adaptability of transaction-related data handling systems. In various embodiments, the retention policy of an enrichment engine may be based on the types of events received and processed. For example, CP-proximate event enrichment engines may utilize retention policies of 12 to 48 hours and CP-distant enrichment engines may utilize retention policies of 90 to 365 days. In such examples, the retention policies may be configured to ensure events related to a particular transaction are received prior to the first event being discarded. Accordingly, CP-proximate events (e.g., gateway outcome or transaction attribute events) for a transaction are expected to be received for a transaction within 12 to 48 hours and CP-distant events (e.g., refund or dispute events) are expected to be received for a transaction within 90 to 365 days.

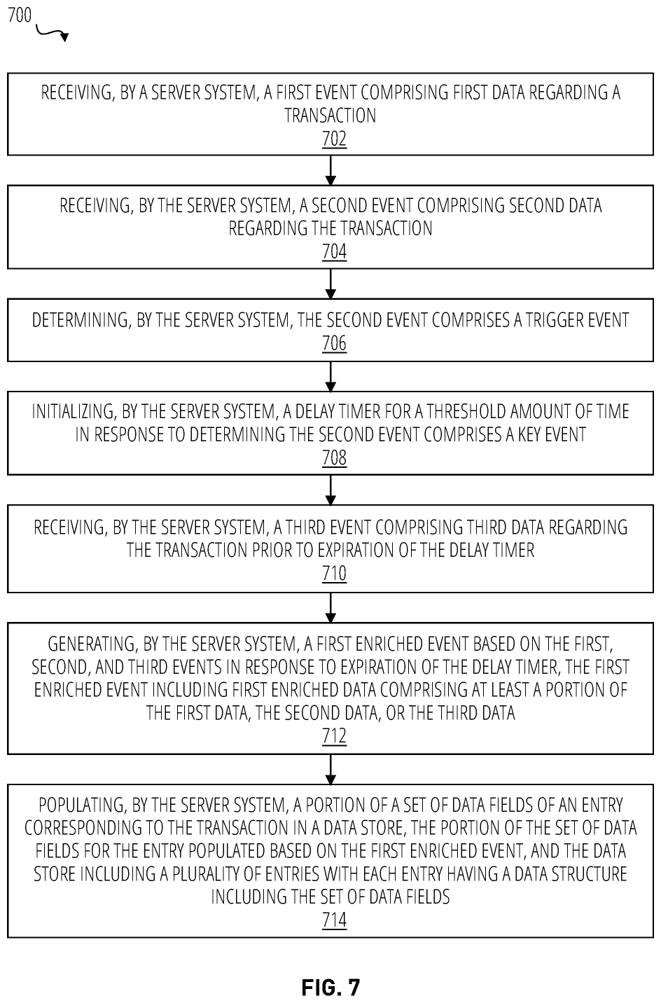

FIG. 7 illustrates a logic flow 700 of a method for handling transaction-related events according to some embodiments. The logic flow 700 is performed by processing logic that may comprise hardware (circuitry, dedicated logic, etc.), software (such as is run on a general purpose computer system or a dedicated machine), firmware, or a combination. In various embodiments, the logic flow 700 is performed by one or more of a commerce platform system (e.g., commerce platform system 104), a server system (e.g., server system 110 or server system 402), and a transaction event data pipeline (e.g., transaction event data pipeline 114, transaction event data pipeline 202, transaction event data pipeline 306, or transaction event data pipeline 404). Embodiments are not limited in this context.

Referring to FIG. 7, the logic flow 700 begins at block 702. At block 702, a first event comprising first data regarding a transaction may be received by a server system. For example, CP-proximate event enrichment engine 408a of server system 402 may receive a first event from event distributor 406a comprising first data regarding a transaction. In some embodiments, the first event may be generated by a CP-proximate event producer and communicated to the event distributor 406a. In various embodiments, event distributor 406a may include a topic in an event streaming service that is subscribed to by the CP-proximate event enrichment engine 408a. For example, the first event may include a transaction attribute event that is generated, at least in part, based on attributes retrieved or determined as part of the charge path that processes the transaction. In many such examples, the first event may be generated asynchronously with the charge path to avoid introducing latency into the charge path.

Proceeding to block 704, a second event comprising second data regarding the transaction may be received by the server system. For example, CP-proximate event enrichment engine 408a of server system 402 may receive a second event from event distributor 406b comprising second data regarding the transaction. In such examples, the second event may include a gateway outcome event. Continuing to block 706, the server system may determine the second event comprises a trigger event. For example, CP-proximate event enrichment engine 408a may determine the second event is a trigger event based on the second event including a gateway outcome.

In response to determining the second event comprises a trigger event, the server system may initialize a delay timer for a threshold amount of time at block 708. For example, CP-proximate event enrichment engine 408a may initialize a delay timer for a threshold amount of time between 0.5 and 2 seconds (e.g., 1 second). In various embodiments, the threshold amount of time may be configured to increase the likelihood that all event regarding the transaction have been received prior to an enriched event for the transaction being generated. As such, this delay can reduce computer resource demands by minimizing the generation and processing of enriched events.

At block 710, a third event comprising third data regarding the transaction may be received by the server system. For example, CP-proximate event enrichment engine 408a may receive a third event from event distributor 406a comprising third data regarding the transaction. In such examples, the third event may include a fraud analysis event that includes data associated with a fraud analysis performed during the charge path of the transaction. Continuing to block 712, a first enriched event may be generated by the server system in response to expiration of the delay timer. The first enriched event may include at least a portion of the first data, the second data, or the third data. For example, CP-proximate event enrichment engine 408a may generate a first enriched event based on the transaction event attribute, the gateway outcome event, and the fraud analysis event. In many such examples, the CP-proximate event enrichment engine 408a may implement a set of rules in generating the enriched event. The set of rules may determine which data to include and which data to excluded from the enriched event. For instance, duplicative data may be excluded from the enriched event. In an additional, or alternative instance, data may be excluded based on privacy policies. In one embodiment, data based on transactions across the entire server system may be excluded or redacted from enriched events to prevent said data from being exposed to merchants in violation of a privacy policy. Accordingly, many embodiment may improve system integrity and confidentiality.

Continuing to block 714, a portion of a set of data fields of an entry corresponding to the transaction may be populated in a data store. Further, the data store may include a plurality of entries with each entry having a data structure including the set of data fields. For example, a portion of the set of data fields of an entry in transaction record table 422 corresponding to the transaction may be populated. In some embodiments, the transaction record table 422 may be stored in a data store included in or communicatively coupled to transaction data manager 418. In many embodiments, the transaction record table 422 may be made available to one or more transaction data interfaces and/or analysis components. In several embodiments, the transaction record table 422 may be made available to one or more merchant facing interfaces and/or analysis components.

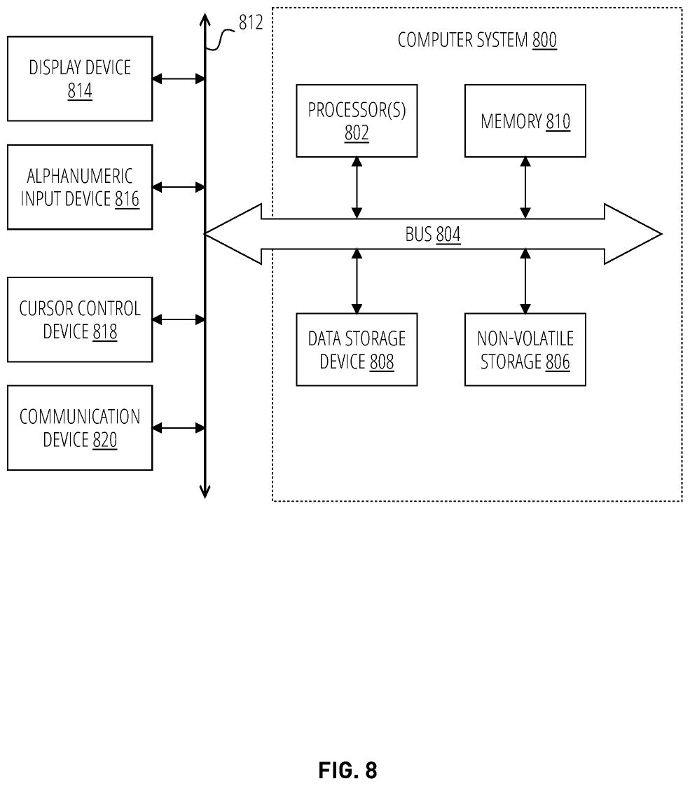

FIG. 8 is one embodiment of a computer system that may be used to support the systems and operations discussed herein. For example, the computer system illustrated in FIG. 8 may be used by a commerce platform system, a server system, a transaction data pipeline, a merchant development system, user system, etc. It will be apparent to those of ordinary skill in the art, however that other alternative systems of various system architectures may also be used.

The data processing system illustrated in FIG. 8 includes a bus or other internal communication means 804 for communicating information, and one or more processors 802 coupled to the bus 804 for processing information. The system further comprises a random access memory (RAM) or other volatile storage device (referred to as memory 810), coupled to bus 804 for storing information and instructions to be executed by processor 802. Memory 810 (e.g., main memory) also may be used for storing temporary variables or other intermediate information during execution of instructions by processor 802. The system also comprises non-volatile storage 806 (e.g., read only memory (ROM) and/or static storage device) coupled to bus 804 for storing static information and instructions for processor 802, and a data storage device 808 such as a magnetic disk or optical disk and its corresponding disk drive. Data storage device 808 is coupled to bus 804 for storing information and instructions.

The system may further be coupled to a display device 814, such as a light emitting diode (LED) display or a liquid crystal display (LCD) coupled to bus 804 through bus 812 for displaying information to a computer user. An alphanumeric input device 816, including alphanumeric and other keys, may also be coupled to bus 804 through bus 812 for communicating information and command selections to processor 802. An additional user input device is cursor control device 818, such as a touchpad, mouse, a trackball, stylus, or cursor direction keys coupled to bus 804 through bus 812 for communicating direction information and command selections to processor 802, and for controlling cursor movement on display device 814.

Another device, which may optionally be coupled to computer system 800, is a communication device 820 for accessing other nodes of a distributed system via a network. The communication device 820 may include any of a number of commercially available networking peripheral devices such as those used for coupling to an Ethernet, token ring, Internet, or wide area network. The communication device 820 may further be a null-modem connection, or any other mechanism that provides connectivity between the computer system 800 and the outside world. Note that any or all of the components of this system illustrated in FIG. 8 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 810 (e.g., main memory), data storage device 808 (e.g., mass storage device), non-volatile storage 806 (e.g., ROM), or other storage medium locally or remotely accessible to processor 802.

It will be apparent to those of ordinary skill in the art that the system, method, and process described herein can be implemented as software stored in memory 810, non-volatile storage 806, and/or data storage device 808 and executed by processor 802. This control logic or software may also be resident on an article of manufacture comprising a computer readable medium having computer readable program code embodied therein and being readable by the data storage device 808 and for causing the processor 802 to operate in accordance with the methods and teachings herein.

The embodiments discussed herein may also be embodied in a handheld or portable device containing a subset of the computer hardware components described above. For example, the handheld device may be configured to contain only the bus 804, the processor 802, and memory 810 and/or non-volatile storage 806. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 802, a data storage device 808, a bus 804, and memory 810, and only rudimentary communications mechanisms, such as a small touch-screen that permits the user to communicate in a basic manner with the device. In general, the more special-purpose the device is, the fewer of the elements need be present for the device to function.

There are a number of example embodiments described herein.

Example 1 is a computer-implemented method for handling transaction-related data. The method can include receiving, by a server system, a first event comprising first data regarding a transaction; receiving, by the server system, a second event comprising second data regarding the transaction; determining, by the server system, the second event comprises a trigger event; initializing, by the server system, a delay timer for a threshold amount of time in response to determining the second event comprises the trigger event; receiving, by the server system, a third event comprising third data regarding the transaction prior to expiration of the delay timer; generating, by the server system, a first enriched event based on the first, second, and third events in response to expiration of the delay timer, the first enriched event including first enriched data comprising at least a portion of the first data, the second data, or the third data; and populating, by the server system, a portion of a set of data fields of an entry corresponding to the transaction in a data store, the portion of the set of data fields for the entry populated based on the first enriched event, and the data store including a plurality of entries with each entry having a data structure including the set of data fields.

Example 2 is a computer-implemented method of Example 1 that may optionally include that the first, second, and third events correspond to one or more of a gateway outcome of the transaction and fraud analysis results of the transaction.

Example 3 is a computer-implemented method of Example 1 or 2, that may optionally include that the first, second, and third events are generated asynchronously with a charge path that processes at least a portion of the transaction.

Example 4 is a computer-implemented method of any combination of Examples 1-3 that may optionally include that the second event comprises a gateway outcome event and the second data includes a gateway outcome of the transaction.

Example 5 is a computer-implemented method of any combination of Examples 1-4 that may optionally include that the first, second, and third events are received by a first enrichment engine of the server system and the first enriched event is generated by the first enrichment engine, and the method may optionally include receiving, by a second enrichment engine of the server system, a fourth event comprising fourth data regarding the transaction; generating, by the second enrichment engine of the server system, a second enriched event based on the fourth event, the second enriched event including second enriched data comprising at least a portion of the fourth data; and populating, by the server system, a data field in the set of data fields for the entry in the data store based on the second enriched data, wherein the data field is separate from the portion of the set of data fields for the entry populated based on the first enriched data.

Example 6 is a computer-implemented method of any combination of Examples 1-5 that may optionally include that the first enrichment engine of the server system has a first data retention policy that causes events received by the first enrichment engine to be stored and then discarded after a first amount of time and the second enrichment engine of the server system has a second data retention policy that causes events received by the second enrichment engine to be stored and then discarded after a second amount of time, wherein the first amount of time is less than the second amount of time.

Example 7 is a computer-implemented method of any combination of Examples 1-6 that may optionally include that the fourth event corresponds to at least one of a refund corresponding to the transaction, a dispute corresponding to the transaction, or a fraud record associated with the transaction.

Example 8 is a computer-implemented method of any combination of Examples 1-7 that may optionally include receiving a fifth event comprising fifth data regarding the transaction; generating a third enriched event based on the fifth event, the third enriched event including third enriched data comprising at least a portion of the fifth data; and updating the data field in the set of data fields for the entry in the data store based on the third enriched data.

Example 9 is a computer-implemented method of any combination of Examples 1-8 that may optionally include that the transaction corresponds to a purchase of a product or service with a payment card.

Example 10 is a computer-implemented method of any combination of Examples 1-9 that may optionally include that the set of data fields include a plurality of fields for structured data and at least one field for unstructured data.

Example 11 is a non-transitory computer readable storage medium including instructions that, when executed by a processor, cause the processor to perform operations for handling card testing attacks according to any combination of Examples 1-10.

Example 12 is a server computer system for handling card testing attacks, comprising: a memory; and a processor coupled to the memory configured to perform operations for handling card testing attacks according to any combination of Examples 1-10.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method for processing transaction-related data, the method comprising:
receiving, by a server system, a first event comprising first data regarding a transaction;
receiving, by the server system, a second event comprising second data regarding the transaction;
determining, by the server system, the second event comprises a trigger event;
initializing, by the server system, a delay timer for a threshold amount of time in response to determining the second event comprises the trigger event;
receiving, by the server system, a third event comprising third data regarding the transaction prior to expiration of the delay timer;
generating, by the server system, a first enriched event based on the first, second, and third events in response to expiration of the delay timer, the first enriched event including first enriched data comprising at least a portion of the first data, the second data, or the third data; and
populating, by the server system, a portion of a set of data fields of an entry corresponding to the transaction in a data store, the portion of the set of data fields for the entry populated based on the first enriched event, and the data store including a plurality of entries with each entry having a data structure including the set of data fields.

2. The computer-implemented method of claim 1, wherein the first, second, and third events correspond to one or more of a gateway outcome of the transaction and fraud analysis results of the transaction.

3. The computer-implemented method of claim 1, wherein the first, second, and third events are generated asynchronously with a charge path that processes at least a portion of the transaction.

4. The computer-implemented method of claim 1, wherein the second event comprises a gateway outcome event and the second data includes a gateway outcome of the transaction.

5. The computer-implemented method of claim 1, wherein the first, second, and third events are received by a first enrichment engine of the server system and the first enriched event is generated by the first enrichment engine, and the method further comprising:
receiving, by a second enrichment engine of the server system, a fourth event comprising fourth data regarding the transaction;
generating, by the second enrichment engine of the server system, a second enriched event based on the fourth event, the second enriched event including second enriched data comprising at least a portion of the fourth data; and
populating, by the server system, a data field in the set of data fields for the entry in the data store based on the second enriched data, wherein the data field is separate from the portion of the set of data fields for the entry populated based on the first enriched data.

6. The computer-implemented method of claim 5, wherein the first enrichment engine of the server system has a first data retention policy that causes events received by the first enrichment engine to be stored and then discarded after a first amount of time and the second enrichment engine of the server system has a second data retention policy that causes events received by the second enrichment engine to be stored and then discarded after a second amount of time, wherein the first amount of time is less than the second amount of time.

7. The computer-implemented method of claim 5, wherein the fourth event corresponds to at least one of a refund corresponding to the transaction, a dispute corresponding to the transaction, or a fraud record associated with the transaction.

8. The computer-implemented method of claim 7, further comprising:
receiving a fifth event comprising fifth data regarding the transaction;
generating a third enriched event based on the fifth event, the third enriched event including third enriched data comprising at least a portion of the fifth data; and
updating the data field in the set of data fields for the entry in the data store based on the third enriched data.

9. The computer-implemented method of claim 1, wherein the set of data fields include a plurality of fields for structured data and at least one field for unstructured data.

10. A non-transitory computer readable storage medium including instructions that, when executed by a processor, cause the processor to perform operations for handling transaction-related data, the operations comprising:
receiving, by a server system, a first event comprising first data regarding a transaction;
receiving, by the server system, a second event comprising second data regarding the transaction;
determining, by the server system, the second event comprises a trigger event;
initializing, by the server system, a delay timer for a threshold amount of time in response to determining the second event comprises the trigger event;
receiving, by the server system, a third event comprising third data regarding the transaction prior to expiration of the delay timer;
generating, by the server system, a first enriched event based on the first, second, and third events in response to expiration of the delay timer, the first enriched event including first enriched data comprising at least a portion of the first data, the second data, or the third data; and
populating, by the server system, a portion of a set of data fields of an entry corresponding to the transaction in a data store, the portion of the set of data fields for the entry populated based on the first enriched event, and the data store including a plurality of entries with each entry having a data structure including the set of data fields.

11. The non-transitory computer readable storage medium of claim 10, wherein the first, second, and third events are generated asynchronously with a charge path that processes at least a portion of the transaction.

12. The non-transitory computer readable storage medium of claim 10, wherein the first, second, and third events are received by a first enrichment engine of the server system and the first enriched event is generated by the first enrichment engine, and the operations further comprising:
receiving, by a second enrichment engine of the server system, a fourth event comprising fourth data regarding the transaction;
generating, by the second enrichment engine of the server system, a second enriched event based on the fourth event, the second enriched event including second enriched data comprising at least a portion of the fourth data; and
populating, by the server system, a data field in the set of data fields for the entry in the data store based on the second enriched data, wherein the data field is separate from the portion of the set of data fields for the entry populated based on the first enriched data.

13. The non-transitory computer readable storage medium of claim 12, wherein the first enrichment engine of the server system has a first data retention policy that causes events received by the first enrichment engine to be stored and then discarded after a first amount of time and the second enrichment engine of the server system has a second data retention policy that causes events received by the second enrichment engine to be stored and then discarded after a second amount of time, wherein the first amount of time is less than the second amount of time.

14. The non-transitory computer readable storage medium of claim 12, wherein the fourth event corresponds to at least one of a refund corresponding to the transaction, a dispute corresponding to the transaction, or a fraud record associated with the transaction.

15. A server computer system for handling transaction-related data, comprising:
a memory; and
a processor coupled to the memory configured to:
receive, by a server system, a first event comprising first data regarding a transaction;
receive, by the server system, a second event comprising second data regarding the transaction;
determine, by the server system, the second event comprises a trigger event;
initialize, by the server system, a delay timer for a threshold amount of time in response to determining the second event comprises the trigger event;
receive, by the server system, a third event comprising third data regarding the transaction prior to expiration of the delay timer;
generate, by the server system, a first enriched event based on the first, second, and third events in response to expiration of the delay timer, the first enriched event including first enriched data comprising at least a portion of the first data, the second data, or the third data; and
populate, by the server system, a portion of a set of data fields of an entry corresponding to the transaction in a data store, the portion of the set of data fields for the entry populated based on the first enriched event, and the data store including a plurality of entries with each entry having a data structure including the set of data fields.

16. The server computer system of claim 15, wherein the first, second, and third events are generated asynchronously with a charge path that processes at least a portion of the transaction.

17. The server computer system of claim 15, wherein the first, second, and third events are received by a first enrichment engine of the server system and the first enriched event is generated by the first enrichment engine, and the processor coupled to the memory further configured to:
receive, by a second enrichment engine of the server system, a fourth event comprising fourth data regarding the transaction;
generate, by the second enrichment engine of the server system, a second enriched event based on the fourth event, the second enriched event including second enriched data comprising at least a portion of the fourth data; and
populate, by the server system, a data field in the set of data fields for the entry in the data store based on the second enriched data, wherein the data field is separate from the portion of the set of data fields for the entry populated based on the first enriched data.

18. The server computer system of claim 17, wherein the first enrichment engine of the server system has a first data retention policy that causes events received by the first enrichment engine to be stored and then discarded after a first amount of time and the second enrichment engine of the server system has a second data retention policy that causes events received by the second enrichment engine to be stored and then discarded after a second amount of time, wherein the first amount of time is less than the second amount of time.

19. The server computer system of claim 17, wherein the fourth event corresponds to at least one of a refund corresponding to the transaction, a dispute corresponding to the transaction, or a fraud record associated with the transaction.

20. The server computer system of claim 19, wherein the processor coupled to the memory further configured to:
receiving a fifth event comprising fifth data regarding the transaction;
generating a third enriched event based on the fifth event, the third enriched event including third enriched data comprising at least a portion of the fifth data; and
updating the data field in the set of data fields for the entry in the data store based on the third enriched data.
